(19) United States
(12) Patent Application Publication
(10) Pub. No.: US 2025/0257810 A1
(43) Pub. Date: Aug. 14, 2025

(54) ISOLATION BYPASS VALVE

(71) Applicant: NIBCO Inc., Elkhart, IN (US)

(72) Inventor: Christopher W. Mason, Granger, IN (US)

(73) Assignee: NIBCO Inc., Elkhart, IN (US)

(21) Appl. No.: 18/804,203

(22) Filed: Aug. 14, 2024

Related U.S. Application Data
(60) Provisional application No. 63/551,283, filed on Feb. 8, 2024.

(51) Int. Cl. F16K 11/22; F16K 11/10; F16L 41/00

(52) U.S. Cl. CPC F16K 11/22; F16K 11/105; F16L 41/008

(57) ABSTRACT

An isolation bypass valve assembly includes a bypass valve located between two tees in the valve body. One or more of the ports extending from the tees can include an isolation valve.

### CLAIM OF PRIORITY

The present application claims the priority benefits under the provisions of 35 U.S.C. § 119, basing said claim of priority on related U.S. Provisional Application No. 63/551,283 filed Feb. 8, 2024, which is incorporated in its entirety herein by reference.

### FIELD OF THE INVENTION

The present invention relates to an isolation bypass valve and associated methods for use in a plumbing system with appliances.

### BACKGROUND OF THE INVENTION

The present invention relates to an isolation bypass valve. Valves incorporating bypass features can be used with water filters, water softeners, descaling pumps, humidifiers, and other appliances that may require bypass in order to service or replace the appliance but still allowing water supply to flow to the main system. While a bypass valve permits flow to be open or closed to one component, it does not typically include isolation valve(s) that allow for isolation of the individual pathways coming to or from the bypass valve. In addition, sometimes it is necessary to ensure that the water pressure is suitable before turning on or off an associated bypass and/or isolation valve.

A number of components are typically necessary to couple a bypass valve and branch assemblies to an appliance. This typically includes at least one segment of piping in between the appliance, the valve, and the bypass segment. This creates additional leak paths, takes additional time to assemble, and takes space given the number of components. An improved assembly that eliminates a number of components and potential leak paths while providing the ability to determine if the appliance is becoming clogged or requires service is described herein.

### SUMMARY OF THE INVENTION

One aspect of the present invention is an isolation valve that includes a body having a first end portion, a second end portion, and a fluid passageway extending between the first end portion and the second end portion. A first branch is positioned near the first end portion and a second branch is positioned near the second end portion. The first and second branches are positioned generally perpendicular to the fluid passageway. A first valve member is positioned in the fluid passageway between the first branch and the second branch. A second valve member is positioned on the first branch and a third valve member is positioned on the second branch.

Another aspect of the present invention is an isolation valve assembly that includes a body having a first end portion, a second end portion, and a fluid passageway extending between the first end portion and the second end portion. A first branch is positioned near the first end portion and a second branch is positioned near the second end portion. The first and second branches are positioned generally perpendicular to the fluid passageway. A first valve member is positioned in the fluid passageway between the first branch and the second branch. A second valve member is positioned on the first branch and a third valve member is positioned on the second branch. A first gauge port is positioned on the body on the first end portion and a second gauge port is positioned on the body on the second end portion.

Yet another aspect of the present invention is a piping assembly with an isolation valve. The piping assembly includes an isolation valve having a body having a first end portion, a second end portion, and a fluid passageway extending between the first end portion and the second end portion. A first branch is positioned near the first end portion and a second branch is positioned near the second end portion. The first and second branches are positioned generally perpendicular to the fluid passageway. A first valve member is positioned in the fluid passageway between the first branch and the second branch. A second valve member is positioned on the first branch and a third valve member is positioned on the second branch. An incoming water supply pipe is coupled to the first end portion. An outgoing water supply pipe is coupled to the second end portion.

These and other advantages of the invention will be further understood and appreciated by those skilled in the art by reference to the following written specification, claims, and appended drawings.

### BRIEF DESCRIPTION OF THE DRAWINGS

FIG. 1 is a front perspective view of one embodiment of an isolation valve;

FIG. 2 is a cross-sectional view and end view of a coupling for one end of the isolation valve shown in FIG. 1;

FIG. 3 is a cross-sectional view and end view of the coupling show in in FIG. 2 with a check valve insert;

FIG. 4 is a cross-sectional view and end view of the coupling shown in FIG. 1 with the check valve insert reversed;

FIG. 5 is a front perspective view of the coupling shown in FIG. 2;

FIG. 6 is a side perspective view of the coupling shown in FIG. 2; and

FIG. 7 is a front perspective view of a variety of options for the coupling members that can be used on the isolation valve shown in FIG. 1.

### DETAILED DESCRIPTION OF THE PREFERRED EMBODIMENTS

For purposes of description herein, the terms “upper,” “lower,” “right,” “left,” “rear,” “front,” “vertical,” “horizontal,” and derivatives thereof shall relate to the invention as oriented in the attached drawings. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

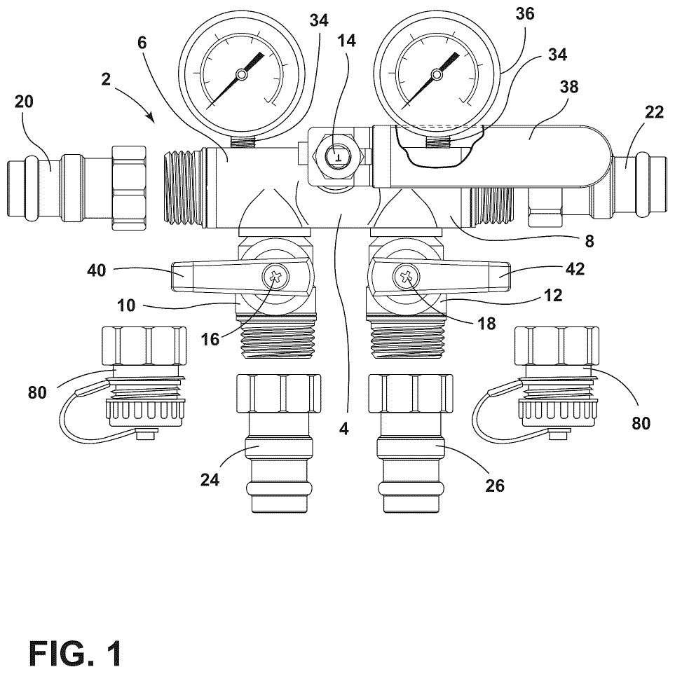

By way of overview, the present invention is generally directed to isolation valve 2, as shown in FIG. 1. The isolation valve 2 has a body 4. The body 4 can be made of any material, including, but not limited to, a lead-free brass alloy. The body 4 has a first end portion 6 and a second end portion 8. A fluid passageway extends between the first end portion 6 and the second end portion 8. The body 4 has a first branch 10 and a second branch 12. In the illustrated embodiment, the first branch 10 is positioned adjacent to the first end portion 6 and the second branch 12 is positioned adjacent to the second end portion 8. While the illustrated embodiments show two branches 10, 12, three or more branches could be present.

The first branch 10 and second branch 12 are illustrated as being perpendicular to the fluid passageway that extends between the first end portion 6 and the second end portion 8. However, the first branch 10 and second branch 12 could be positioned in other orientations on the body 4 of isolation valve 2. Moreover, the first branch 10 and the second branch 12 do not need to be oriented in the same direction.

A first valve member 14 is position in the fluid passageway between the first branch 10 and the second branch 12 on the valve body 4. In the illustrated embodiment, the first valve 14 is actuated by handle 38. The first valve 14 can be an L-style ball with two openings or a T-style ball with three openings. In the illustrated embodiment, the first valve member 14 is a T-style ball valve. The first valve member 14 permits flow to between the first end portion 6, second end portion 8, and both branches 10, 12 in a first position as shown in FIG. 1. When the first valve member 14 is rotated 90° in either direction, the second end portion 8 and the second branch 12 are isolated from the first end portion 6 and the first branch 10. A second valve member 16 is positioned on the first branch 10. A third valve member 18 is positioned on the second branch 12. The second and third valves members 16, 18 include a flow diversion member, such as a ball, in the fluid passageway of the respective branch 10, 12. The second valve member 16 and third valve member 18 allow the opening and closing of the fluid passageway to the ends of the first branch 10 and second branch 12, respectively.

The valve body 4 includes gauge ports 34 that permit the installation of one or more gauge(s) 36 to the valve body 4. One gauge port 34 is positioned between the first end portion 6 and the first branch 10, as illustrated in FIG. 1, and the second gauge port 34 is positioned between the second end portion 8 and the second branch 12, as illustrated in FIG. 1. In the illustrated embodiments, the gauge ports 34 are positioned on the opposite side of the body 4 from the first branch 10 and the second branch 12. However, other orientations of the gauge ports 34 can be used. The use of the gauges 36 allow the measurement of the pressure from the inflow to the outflow to assess if the corresponding appliance is becoming clogged and/or requires service.

An appliance, such as a water filter, water softener, descaling pump, humidifier, etc. can be coupled to one or both of the first branch 10 and/or second branch 12. When one appliance is coupled to one of the branches 10 or 12, the other branch can be used to drain the appliance, fill the appliance, or bypass the appliance to components in the plumbing system.

In the illustrated embodiment, the first end portion 6, second end portion 8, first branch portion 10, and second branch portion 12 include terminal ends that are threaded thereby allowing for the coupling of female fittings. A first coupling member 20 is coupled to the first end portion 6, a second coupling member 22 is coupled to the second end portion 8, a third coupling member 24 is coupled to the first branch 10, and a fourth coupling member 26 is coupled to the second branch portion 12, as illustrated in FIG. 1. Caps 80 may alternatively be coupled in place of one or more of the coupling members if that particular inlet/outlet is not being used.

The use of union fittings makes for easy connection and/or removal of the isolation valve 2 from the plumbing system and/or from one or more appliances. In the illustrated embodiments, the coupling members 20, 22, 24, and 26 include press connections. The press connection utilizes one or more sealing members 54, 56 to couple to a pipe while the EPDM gasket seal 50 helps seal the female fitting 52 to the threaded surface on the valve body 4.

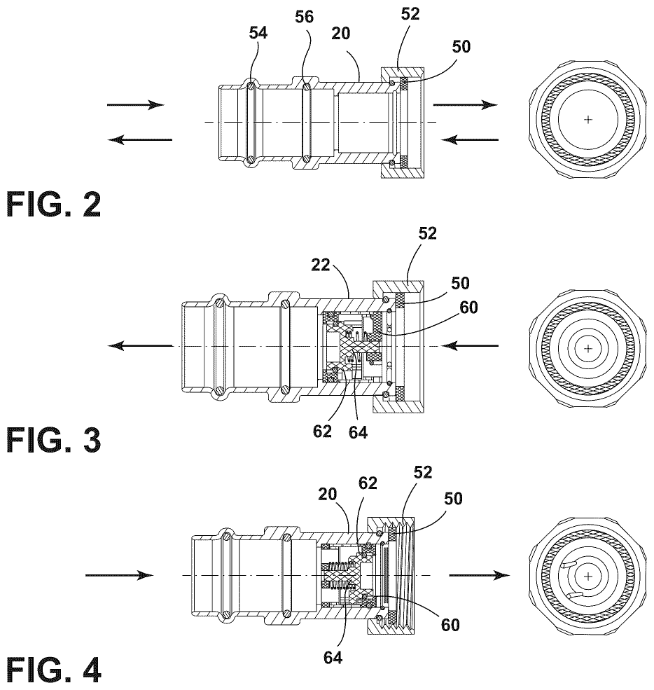

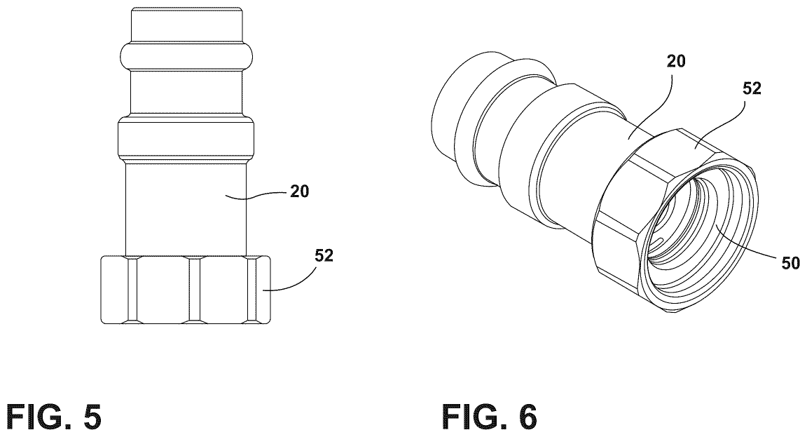

A check valve insert 60 (FIGS. 3 and 4) may be used to help prevent backflow from the appliance and/or from the plumbing system. The check valve inserts 60 are removable and reversible, allowing for flow path configurability as shown in FIGS. 2 and 3. For example, the first coupling member 20 could include a check valve insert 60 positioned as shown in FIG. 4 to prevent backflow from the isolation valve 2 to an incoming water supply pipe that is coupled to first coupling member 20. The second empty member 22 could include a check valve insert 60, as shown in FIG. 3, to prevent backflow from the outgoing water supply pipe that is coupled to the second coupling member 22. Similarly, if an appliance is coupled to either branch 10, 12, a check valve insert 60 could be used in the coupling member 24, 26 to prevent backflow from the appliance. The check valve insert 60 includes a spring member 64 and a diaphragm 62. The diaphragm 62 flexes open when the pressure on the upside is greater than the pressure on the downside and closes when the pressure is equalized or lowered due to the presence of the spring member 64.

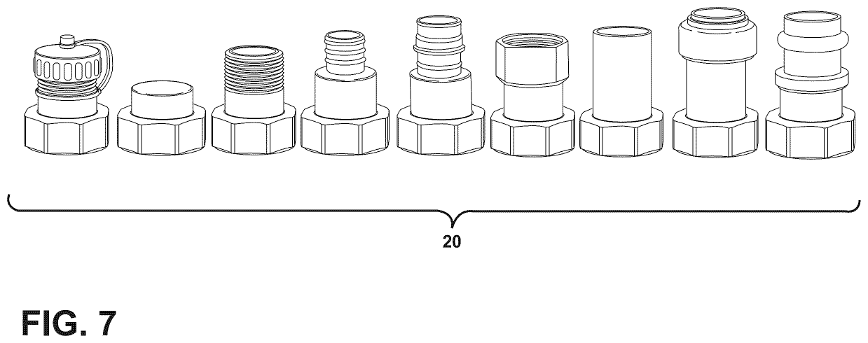

As illustrated in FIG. 7, a variety of coupling members can be used for the first coupling member 20, second coupling member 22, third coupling member 24, and/or fourth coupling member 26. The first coupling member 20, second coupling member 22, third coupling member 24, and fourth coupling member 26 can be of similar styles and/or sizes. While the embodiment shown in FIG. 1 shows the coupling members 20, 22, 24, and 26 all being press couplings, any type of coupling member can be used, including those shown in FIG. 7 which, from left to right, are hose-end, cap, male iron pipe, PEX, female iron pipe, sweat, push-to-connect, and press fittings.

In the foregoing description, it will be readily appreciated by those skilled in the art that modifications may be made to the invention without departing from the concepts disclosed herein. Such modifications are to be considered as included in the following claims, unless these claims by their language expressly state otherwise.

It will be understood by one having ordinary skill in the art that construction of the present disclosure and other components is not limited to any specific material. Other exemplary embodiments of the disclosure disclosed herein may be formed from a wide variety of materials, unless described otherwise herein.

For purposes of this disclosure, the term “coupled” or “operably coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

For purposes of this disclosure, the term “connected” or “operably connected” (in all of its forms, connect, connecting, connected, etc.) generally means that one component functions with respect to another component, even if there are other components located between the first and second component, and the term “operable” defines a functional relationship between components.

It is also important to note that the construction and arrangement of the elements of the present disclosure as shown in the exemplary embodiments is illustrative only. Although only a few embodiments of the present innovations have been described in detail in this disclosure, those skilled in the art who review this disclosure will readily appreciate that, unless otherwise described, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating positions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

What is claimed is:

1. An isolation valve, comprising:
a body having a first end portion, a second end portion, a fluid passageway extending between said first end portion and said second end portion, a first branch positioned near said first end portion, a second branch positioned near said second end portion, said first and second branches positioned generally perpendicular to said fluid passageway;
a first valve member positioned in said fluid passageway between said first branch and said second branch;
a second valve member positioned on said first branch; and
a third valve member positioned on said second branch.

2. The isolation valve of claim 1, including a first gauge port positioned on said body on said first end portion and a second gauge port positioned on said body on said second end portion.

3. The isolation valve of claim 2, wherein said first gauge portion is positioned on said body between said first branch and said first end portion.

4. The isolation valve of claim 2, wherein said second gauge port is positioned on said body between said second branch and said second end portion.

5. The isolation valve of claim 2, wherein said first gauge port and said first branch are positioned on opposite sides of said body.

6. The isolation valve of claim 1, wherein said first end portion, said second end portion, said first branch, and said second branch are all threaded.

7. The isolation valve of claim 1, including a check valve positioned in a coupling that is coupled to said first end portion.

8. The isolation valve of claim 1, including a check valve positioned on a coupling that is coupled to said second end portion.

9. An isolation valve assembly, comprising:
a body having a first end portion, a second end portion, a fluid passageway extending between said first end portion and said second end portion, a first branch positioned near said first end portion, a second branch positioned near said second end portion, said first and second branches positioned generally perpendicular to said fluid passageway;
a first valve member positioned in said fluid passageway between said first branch and said second branch;
a second valve member positioned on said first branch;
a third valve member positioned on said second branch; and
a first gauge port positioned on said body on said first end portion and a second gauge port positioned on said body on said second end portion.

10. The isolation valve assembly of claim 9, wherein said first gauge portion is positioned on said body between said first branch and said first end portion.

11. The isolation valve assembly of claim 9, wherein said second gauge port is positioned on said body between said second branch and said second end portion.

12. The isolation valve assembly of claim 9, wherein said first gauge port and said first branch are positioned on opposite sides of said body.

13. The isolation valve assembly of claim 9, wherein said first end portion, said second end portion, said first branch, and said second branch are all threaded.

14. The isolation valve assembly of claim 9, including a check valve positioned in a coupling that is coupled to said first end portion.

15. The isolation valve assembly of claim 9, including a check valve positioned on a coupling that is coupled to said second end portion.

16. A piping assembly with an isolation valve, comprising:
an isolation valve having a body having a first end portion, a second end portion, a fluid passageway extending between said first end portion and said second end portion, a first branch positioned near said first end portion, a second branch positioned near said second end portion, said first and second branches positioned generally perpendicular to said fluid passageway;
a first valve member positioned in said fluid passageway between said first branch and said second branch;
a second valve member positioned on said first branch;
a third valve member positioned on said second branch;
an incoming water supply pipe coupled to said first end portion; and
an outgoing water supply pipe coupled to said second end portion.

17. The piping assembly of claim 16, including a first gauge port positioned on said body on said first end portion and a second gauge port positioned on said body on said second end portion.

18. The piping assembly of claim 17, wherein said first gauge port and said first branch are positioned on opposite sides of said body.

19. The piping assembly of claim 16, including a check valve positioned in a coupling that is coupled to said first end portion to prevent backflow from said piping assembly into said incoming water supply pipe.

20. The piping assembly of claim 16, including a check valve positioned on a coupling that is coupled to said second end portion to prevent backflow from said outgoing water supply pipe into said piping assembly.
